(19) United States
(12) Patent Application Publication
(10) Pub. No.: US 2023/0147096 A1
(43) Pub. Date: May 11, 2023

(54) UNSTRUCTURED DATA STORAGE AND RETRIEVAL IN CONVERSATIONAL ARTIFICIAL INTELLIGENCE APPLICATIONS

(71) Applicant: Nvidia Corporation, Santa Clara, CA (US)

(72) Inventors: Vlad Getselevich, Los Gatos, CA (US); Purnendu Mukherjee, San Jose, CA (US)

(21) Appl. No.: 17/521,232

(22) Filed: Nov. 8, 2021

(51) Int. Cl. G06F 16/332; G06F 40/40; G06F 16/35; G06N 3/04

(52) U.S. Cl. CPC G06F 16/3329; G06F 40/40; G06F 16/353; G06N 3/0454

(57) ABSTRACT

Systems and methods determine a classification for an input. For information-based inputs, information stored as unstructured test may be evaluated to determine a response to the input. A reply may be generated that includes at least the response. For declarative inputs, the input may be stored in a natural language format for later use, such as in reply to a subsequent input.

### BACKGROUND

Interaction environments may include conversational artificial intelligence systems that receive a user input, such as a voice input or textual input, and then infer an intent in order to provide a response to the input. These systems are generally trained on large data sets, where each intent is trained to a specific entity, which creates a generally inflexible and unwieldy model. For example, systems may deploy a variety of different models that are specifically trained to each task and when small changes are instituted, the models are then retrained on newly annotated data. Typically, data associated with these systems, such as intent/slot data sets, are stored in structured data schema, which further creates problems with additions or changes. As a result, systems may be inflexible to new information or updates may be slow, which could limit the useability of the systems.

### BRIEF DESCRIPTION OF THE DRAWINGS

Various embodiments in accordance with the present disclosure will be described with reference to the drawings, in which:

FIG. 1 illustrates an example interaction environment, according to at least one embodiment;

FIG. 2 illustrates an example of a pipeline for input classification, storage, and retrieval, according to at least one embodiment;

FIG. 3 illustrates an example environment for classification, storage, and retrieval, according to at least one embodiment;

FIG. 4 illustrates an example interface for an interaction environment, according to at least one embodiment;

FIG. 5A illustrates an example flow chart of a process for input classification, according to at least one embodiment;

FIG. 5B illustrates an example flow chart of a process for input classification and retrieval, according to at least one embodiment;

FIG. 6 illustrates an example flow chart of a process for generating a response according to an input, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

Approaches in accordance with various embodiments provide systems and methods for unstructured storage and retrieval of information, such as information utilized with interaction environments. In at least one embodiment, systems and methods are used with chat bots or conversational artificial intelligence (AI) systems in order to store and retrieval data that may be stored with differed storage schemas and/or without a structured storage schema response to a query. Various embodiments may include one or more classifiers to analyze a user input, determine whether the input is associated with an information-based request, and then direct the input along the appropriate pipeline for analysis, and response. In at least one embodiment, an information-based request may be evaluated using one or more extractive question answer models in order to identify one or more features within the input and determine, from a set of unstructured data, information responsive to the input. The information may then be presented to the user or may be utilized to execute one or more actions, among other options. Moreover, systems and methods may be used to store user inputs as unstructured text, such as storage in a natural-language method, for later retrieval. In this manner, data sets may be easily updated and maintained without the rigidity of conforming each piece of information to a request schema.

Various embodiments may be used, in part, with conversational AI systems that provide information or execute commands responsive to one or more user inputs. In at least one embodiment, a user may provide an input to the environment, such as a request for information or a request to perform one or more tasks. The system may process the input, such as processing an audio input using one or more natural language or speech recognition systems, or may evaluate a textual input to classify the input as belonging to one or more categories. In at least one embodiment, categories may be associated with an information-based input, an intent/slot input, a declaratory input, and others. Depending on the classification, a different processing pipeline may be utilized for the input. By way of example only, an information-based input may be evaluated by one or more extractive question answer models against a data store of unstructured data, where the model may determine or more features from the input to generate a response to the input. As another example, an intent/slot classification may be directed toward a pipeline where a trained extractive question answer model evaluates the input against different intent/slot information in order to populate a slot with an appropriate value to provide a response. As a further example, a declaratory input may be classified and then added to an unstructured data repository, where it may then be utilized or be made available to later user queries.

Various embodiments may be utilized to provide a response to a user input, which may be in the form of an auditory input, a textual input, a selective input (e.g., selecting a content element), or an instructional input, such as a data file that executes one or more operations within the interaction environment. Systems and methods may not only store relevant information as natural text in unstructured memory and answer flexible questions based on the information, but moreover, may retrieve pieces of information to use in commands. For example, a result may be associated with a textural or voice response to a user, as well as or additionally, fulfillment of one or more actions connected to the result. By way of example, one or more meta commands may be added to a responsive output associated with the input, where the command itself is not provided to the user, but the command triggers one or more additional actions.

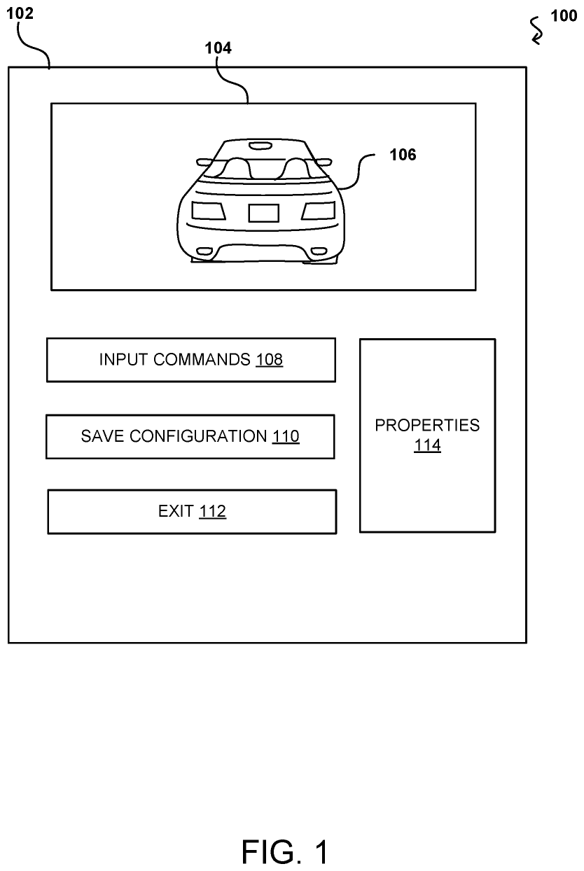

An interaction environment 100 may be presented in a display area 102 that includes one or more content elements, as illustrated in FIG. 1. In at least one embodiment, interaction environment 100 may be associated with a conversational AI system that allows a user to interact with different content elements based, at least in part, on one or more inputs, such as a voice input, a textual input, selection of an area, selection of one or more content elements, or the like. The display area 102 may form a portion of an electronic device, such as a smart phone, personal computer, smart TV, a virtual realty system, an interaction kiosk, or the like. In this example, a display element 104 is illustrated that includes an object 106 corresponding to an automobile. The object 106 is illustrated in a rear-view where a bumper is visible. As will be described below, various embodiments enable a user to provide an input instruction, such as a voice instruction, to modify one or more aspects of the object 106 and/or to perform one or more supported actions within the interaction environment 100 as well as to present one or more queries, such as a question associated with information within the environment.

The illustrated system further includes selectable content elements, which may include an input content element 108, a save content element 110, an exit content element 112, and a property content element 114. It should be appreciated that these selectable content elements are provided by way of example only and that other embodiments may include more or fewer content elements. Furthermore, different types of content elements may be utilized with different types of interaction properties, such as voice commands, manual inputs, or the like. Furthermore, the interaction environment may receive one or more scripts that include a sequence of actions that are used to initiate different commands associated with the selectable content elements. In operation, the user may interact with one or more of the content elements in order to perform one or more tasks or actions associated with the environment, such as changing properties of the object 106. By way of example, the user may select the input content element 108, such as by clicking on it (e.g., with a cursor controlled by a mouse or with a finger), by providing a verbal instruction, or the like. The user's command may then be received and one or more systems may classify the input, determine an appropriate response to the input, and then execute the appropriate response.

Systems and methods may be directed toward storing, retrieving, and updating unstructured text. Embodiments include storing information related to a conversional AI where a user presents a query, the query is evaluated to determine whether it is information based, and then a question-answer neural network model is used to extract facts from the query in order to determine a response from unstructured text. Answers or data to various queries may be stored naturally as unstructured text, rather than in an intent/slot schema that may be difficult to generate and/or update. During operation, an input query is directed toward a classifier that determines whether the query is a question. Moreover, the question is broken into an information based query or an intent/slot query to be directed toward the appropriate pipeline. An extractive QA model may be trained and then used to provide a response to the information based query, such as by searching through the unstructured text to identify an answer to the input query. The system enables development of a conversational AI that is supported with unstructured memory, which may increase custom facts associated with the system.

Embodiments of the present disclosure may provide one or more improvements over existing systems that utilize a structured data schema to store, update, and retrieve information. By way of example, the unstructured, natural language storage of the present embodiments may provide improvements over intent/slot schemas where particular responses or intents are pre-loaded and defined for use with the system. Accordingly, intent/slot schemas are typically generated by looking at a variety of different inputs and desired outputs in order to create intent/slot combinations that are then identified and executed responsive to the input. Generation of these systems may be time consuming and are not flexible to user inputs that do not correspond to the preloaded intents and slots. Similarly, systems provide improvements over variable dictionaries and knowledge graphs that may require rigid classification of information, rather than storage and retrieval of unstructured text.

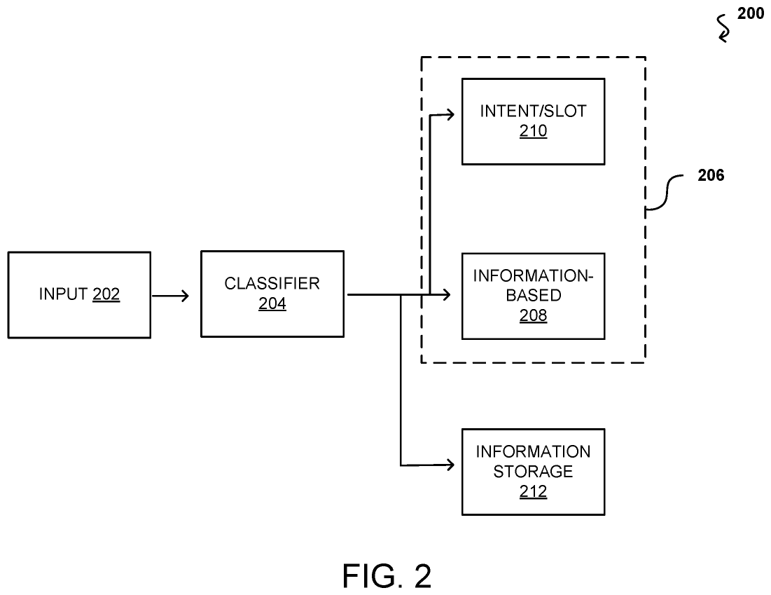

An architecture 200 may include one or more processing units, which may be locally hosted or part of one or more distributed systems, as shown in FIG. 2. In this example, an input 200 is provided to a classifier 204, which may be part of a distributed system or a locally hosted classifier, among other options. The classifier 204 may include one or more trained machine learning systems that evaluate one or more aspects of the input to determine whether the input is associated with a question or not. By way of example only, one or more punctuation models, which may be part of one or more Natural Language Processing (NLP) models, may be utilized to predict whether a punctuation mark follows a word, and moreover, to predict whether an input statement or phrase is a question. Furthermore, at least portions of the classifier 204 may incorporate one or more natural language understanding (NLU) systems that enable humans to interact naturally with devices. The NLU system may be utilized to interpret context and intent of the input to generate a response. For example, the input may be preprocessed, which may include tokenization, lemmatization, stemming, and other processes. Additionally, the NLU system may include one or more deep learning models, such as a BERT model, to enable features such as entity recognition, intent recognition, sentiment analysis, and others. Moreover, various embodiments may further include automatic speech recognition (ASR), text-to-speech processing, and the like.

In operation, the input 202 is evaluated by the classifier 204 and, based at least in part on a classification of the input 202, data may be transferred along one or more pipelines for further processing. In this example, a question environment 206 may include evaluations based on both information-based queries 208 and intent/slot queries 210, among other options. For example, the classifier 204 may initially determine the input 202 corresponds to a question and direct data along an appropriate pipeline to the question environment 206. However, within the question environment, one or more additional analysis or determinations may be performed in order to determine whether appropriate processing is performed by the information-based system 208 or the intent/slot system 210, which as noted above, are examples as there may be additional systems utilized within the question environment 206. By way of example only, one or more functions may be utilized to evaluate and determine how to process an input, as shown below:

```
if question(query):
  response = question_answering(query)
if not response:
  intent, score = recognize_intent(query)
  if intent and score > Threshold: #intent recognized
    slot = recognize_slot(query, slot question)
    slot = check_slot_value(slot, supported slot values)
    response, command = execute_command(intent, slot)
tts.say(response)
```

In this example, the initial query is evaluated and processed using the trained extractive question answering network if the query is a question and if such a query can be processed by the system. However, in other examples, the intent/slot system 210 may proceed with identifying an intent, identifying an associated slot, populating the slot, and then providing a response.

Additionally, the input 202 may further be classified as being a declarative statement and may be directed toward an information storage system 212. For example, the user may provide, as the input 202, an affirmative statement such as “My favorite color is green” or “This should be the default view setting.” This information may then be provided to the information storage system 212 for storage and retention as unstructured natural language, which may then be utilized as a response to another query. As will be appreciated, storage of the input 202 as unstructured natural language enables storage and retrieval in real and near-real time such that data associated with the system may be updated at runtime without retraining the model or modifying intent/slot classifications by adding new intents. In this manner, the conversational AI may be updated more frequently and in a more natural way, using natural language, rather than requiring information to conform to specific data structures.

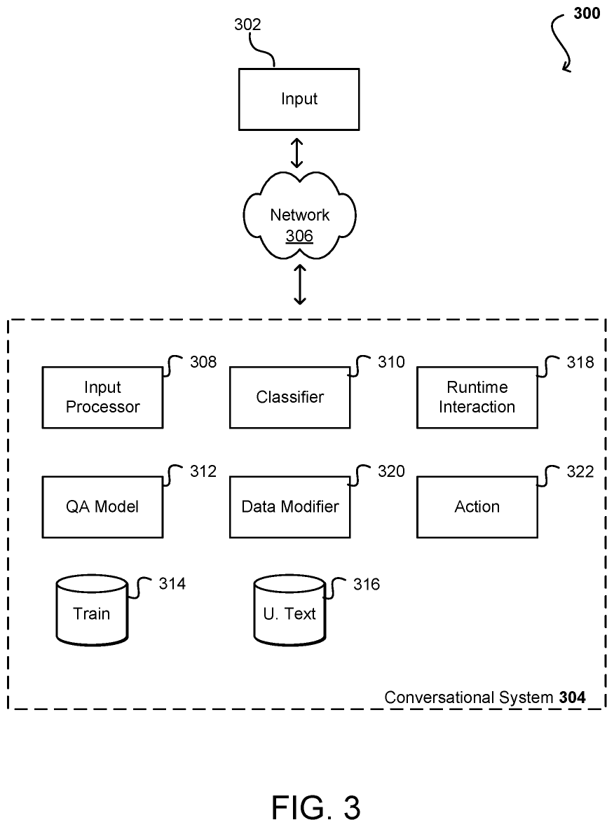

An environment 300 may be utilized with one or more conversational Ais, as shown in FIG. 3. It should be appreciated that the environment 300 may include more or fewer components and that various components of the environment 300 may be incorporated into singular systems, but may be shown as separate modules for convenience and clarity. In this example, an input 302 is transmitted to a conversational system 304 via one or more networks 306. The networks 306 may be wired or wireless networks which include one or more intermediate systems, such as user devices, server components, switches, and the like. Moreover, it should be appreciated that one or more features of the conversational system 304 may be pre-loaded or otherwise stored on a user device such that transmission of at least a portion of data may not utilize the network 306 but may be performed locally on a device.

In this example, an input processor 308 receives the input 308 and may perform one or more pre- or post-processing steps. For example, input processor 308 may include one or more NLP systems that evaluate an auditory input to extract one or more features from the input, among other options. Furthermore, in embodiments, input processor 308 may include a text processing system for preprocessing (e.g., tokenization, removal of punctuation, removal of stop words, stemming, lemmatization, etc.), feature extraction, and the like. It should be appreciated that the input processor 308 may utilize one or more trained machine learning systems and may further be incorporated into other components of the conversational system 304.

A classifier 310 may be used to determine whether the input corresponds to a question, a statement, or any other label. For example, the classifier 310 may utilize one or more trained machine learning systems to evaluate whether an input is in the form of a question, for example using a punctuation model, among other potential models. As noted above, the classifier 310 may then direct the input along different pathways depending on a respective classification, where questions may be further evaluated against one or more data bases to determine a response and statements may be evaluated and added to a corpus of unstructured text.

As noted above, questions may be directed toward a question environment where one or more extractive question answer models 312 are used to determine a response to the input. By way of example, the extractive question answer model 312 may be a trained neural network that is utilized to extract one or more portions of an input sequence to answer a natural language question associated with such a sequence. As noted above, for an input such as “what colors can I paint the car” unstructured text may be evaluated to identify potential colors for the car, where those colors may then be presented to the user. For example, if unstructured text included natural language information such as “car colors are white, black, red, yellow, and gray” then the response to the question would be “white, black, red, yellow, and gray.” Additionally, it should be appreciated that the model 312 may also be utilized with intent/slot evaluations. In various embodiments, the extractive question answer model may be a trained neural network system, such as Megatron from NVIDIA Corporation.

In various embodiments, training data 314 may be utilized to train the model 312, where the data includes a corpus of information, such as the multiQA dataset. As a result, the model 312 may be capable of extracting relevant facts directly from a corpus of unstructured text 316, which corresponds to information provided for the conversational system 304. By way of example, the corpus 316 may include information presented as natural language, such as sentences, paragraphs, CSV data, and the like. Furthermore, the corpus 316 may further include one or more structure datasets.

The illustrated embodiment also includes a runtime interaction module 318 to identify and incorporate different statements or facts that may be utilized to update the corpus 316. By way of example, the classifier 310 may determine that an input is not associated with a question and may provide the input to the runtime interaction module 318 for evaluation, for example using one or more machine learning systems. One or more features may be identified and/or extracted from the input in order to update the corpus 316. For example, the input may correspond to a user preference, such as an utterance that the user prefers a certain color or camera angle. This information may then be utilized to update the corpus 316 such that future commands or requests may incorporate the user's preferences. In at least one embodiment, a data modifier 320 may be utilized to update the corpus 316, such as formatting the input in natural language format.

Various embodiments may also cause one or more actions to be performed that are associated with the input. For example, an action module 322 may be used to implement one or more meta commands associated with natural language text that enables connection to appropriate commands associated with the text. In various embodiments, the meta commands may be a symbol or call to the machine learning systems to ignore or otherwise disregard certain characters, where those characters are associated with the actions. In various embodiments, the action can be executed in parallel or semi-parallel with a response to the input. In at least on embodiment, meta commands may be separate sentences or strings of characters that follow symbol or call. For example, if the user were to ask, “What side dishes come with this meal?” an associated action may be to not only provide a verbal or textual response to the user to answer the question, but to also provide pictures or display a list. As a result, within the unstructured text, the symbol or call may follow the unstructured text associated with the answer such that when the answer to the user input is identified, one or more actions also executes.

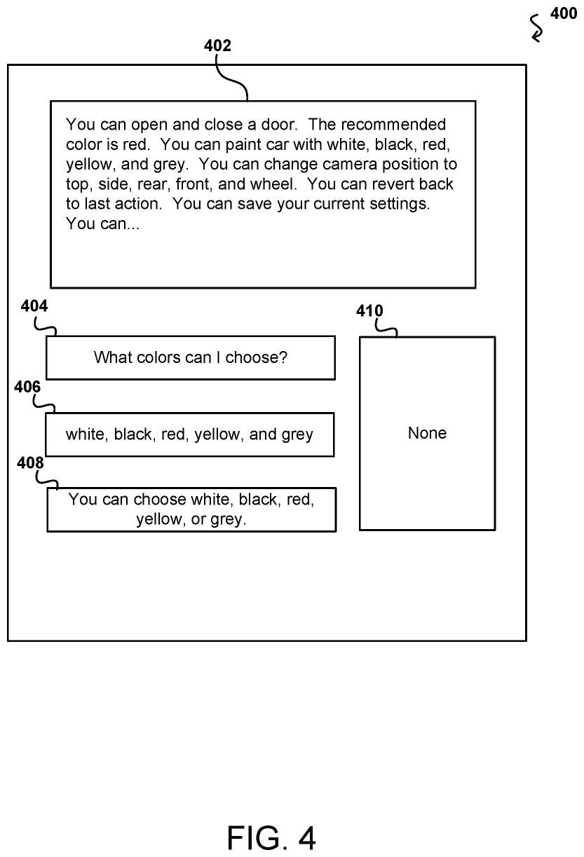

As noted here, various embodiments enable storage and retrieval of information as natural language, unstructured text. Accordingly, new information may be easily added to the corpus of information without formatting to a particular schema. A storage system 400 may include a set of information 402, as illustrated in FIG. 4. The set of information 402 is stored as free text in a natural language format, which in this case is a series of sentences. It should be appreciated that different unstructured memory schema may be used, such as lists (e.g., colors are white, black, red, yellow, and grey), key value pairs (e.g., colors:white, black, red, yellow, grey), and the like. Furthermore, it should be appreciated that different structured schema may also be utilized with the storage system 400 within the set of information 402. In other words, different schema may be combined within the storage system 400 as the set of information 402, thereby providing improved flexibility for storing and updating information.

In this example, an input 404 shows an example of a user query provided to the system 400, which in this instance is a voice input that has been converted to text, for example using one or more NLP systems. It should be appreciated that the input 404 is provided as an example to illustrate the process evaluated by the system 400 and that, in embodiments, the user utilizing the system 400 will not visualize the set of information 402 and/or the input 404. That is, the system 400 may execute in the background while a different user interface is shown to the user. In this example, the input 404 corresponds to a question, which may be identified by one or more classifiers, are described above. Moreover, in various embodiments, the question may be further analyzed to determine whether it is an information-based question. In this instance, the query is related to a question regarding capabilities of the system, which may correspond to an information-based question.

In at least one embodiment, a generative response 408 may be enabled such that the answer 406 is provided in a sentence structure to the user. By way of example, a generative neural network may be utilized to receive, as an input, the answer 406 and then to determine an appropriate response incorporating the answer 406. In this example, the generative response 408 provides the answer 406 in a sentence format to the user. As will be appreciated, using the generative response 408 may provide an improved interaction experience for the user, where the user may feel as if they are engaging in a conversation with the system, as opposed to receiving only the information. Accordingly, the user may be encouraged to use the system for more purposes.

In at least one embodiment, one or more actions may be tied to different user inputs, where the action may include a marker or call, as noted above. An action set 410 may include a list or set of associated actions with different answers 406. In the example of FIG. 4, there are no related actions associated with the user's request to learn about color options. However, in various embodiments, actions could be associated with the request, such as showing a panel or swatch of the color options. Accordingly, different calls or functions may be listed. In at least one embodiment, a provider may access the system 400 to make changes or updates. For example, different information may be added to the set of information 402 and/or different actions may be correlated to different questions or situations. In this manner, dynamic changes to the system may be provided at runtime without retraining the system.

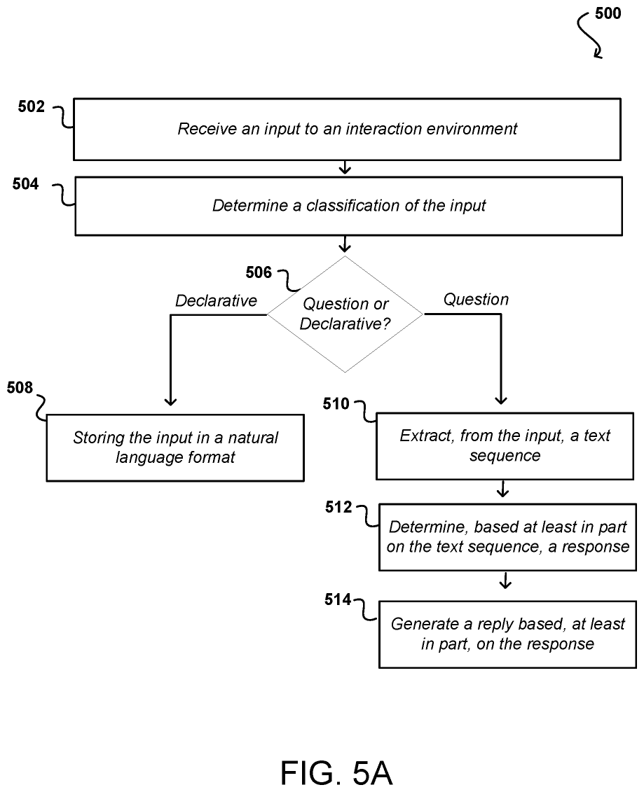

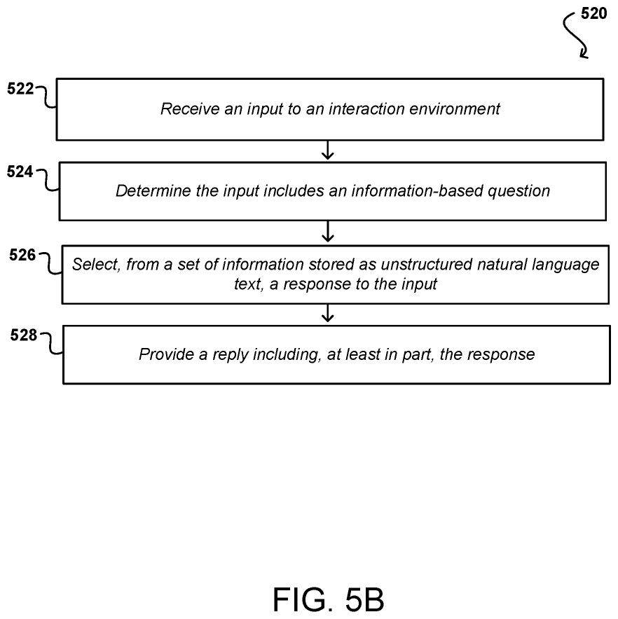

FIG. 5A illustrates an example process 500 for determining a user intent to execute an action within an interaction environment. It should be understood that for this and other processes presented herein that there can be additional, fewer, or alternative steps performed in similar or alternative order, or at least partially in parallel, within the scope of various embodiments unless otherwise specifically stated. In this example an input may be received at an interaction environment 502. In various embodiments, the input may be a voice input, a textual input, a command from a script of software program, a selection of a content element, or the like. A classification of the input may be determined 504, for example using one or more machine learning systems that determine whether the input is a question or a declarative statement 506. As noted above, the determination may include, at least in part, one or more models, such as a punctuation model.

If the information is a declarative statement, such as the user providing information, the input may be stored in a natural language format 508. Storing the input may enable later identification and retrieval of the information, for example, if the user provides information that may be useful for an interaction environment, such as verifying one or more preferences. Furthermore, as discussed herein, storing the information in a natural language format provides flexibility to the system such that a certain storage schema may not be required, which my enable faster, automated storage of the newly provided information.

In at least one embodiment, the input is a question, and one or more text sequences may be extracted from the input 510. The extracted portions of the text sequence may be provided to one or more machine learning systems, such as an extractive question answer model, to determine, based at least in part on the sequence, a response 512. The response may provide an answer to the question posed by the input, where the response may be identified within a set of information stored in an unstructured format, such as a natural language format. The response may then be used to generate a reply to the input 514, such as providing additional information, executing an action, or a combination thereof.

FIG. 5B illustrates an example process 520 for responding to a user input. In this example, an input is received at an interaction environment 522. As noted, the input may include one or more queries that are provided via a voice interaction, textual input, selection of a content element, or other options. In at last one embodiment, the input may include an information-based question 524. For example, the input may be a question regarding the potential capabilities of a conversational AI system. Information from the input may be utilized to evaluate data stored as unstructured natural language in order to determine a response to the input 526. By way of example, an extractive question answer model may take, as an input, one or more features from the input to determine whether information within the stored data is responsive to the input. A reply may then be generated using the response 528.

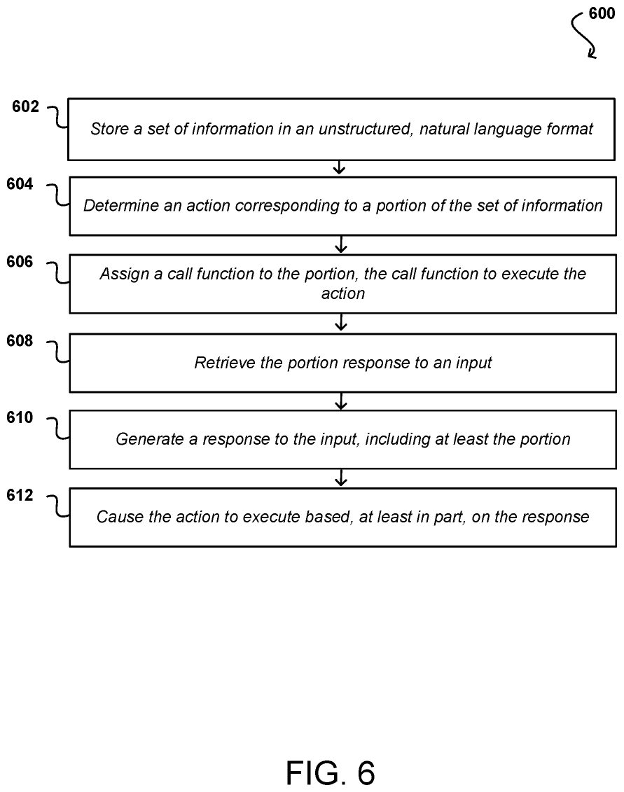

FIG. 6 illustrates an example process 600 for executing an action based on an input. In this example, a set of information is stored as unstructured, natural language 602. For example, the information may be stored as a series of sentences, among other options. An action corresponding to a portion of the information is determined 604. The action may include one or more capabilities of an interaction environment, such as providing a visual indication responsive to a user query. A call function may be assigned to the portion of information, where the call function is used to execute an action 606. The call function, in various embodiments, may include a symbol or indicator so that the call function is not counted or included within the set of information.

In various embodiments, an input is received and the portion is retrieved responsive to the input 608. The portion may be used to generate a response to the input 610 and, based on the response, one or more associated actions may be executed 612. In this manner, the call associated with the portion may be executed in parallel with providing the response.

### Data Center

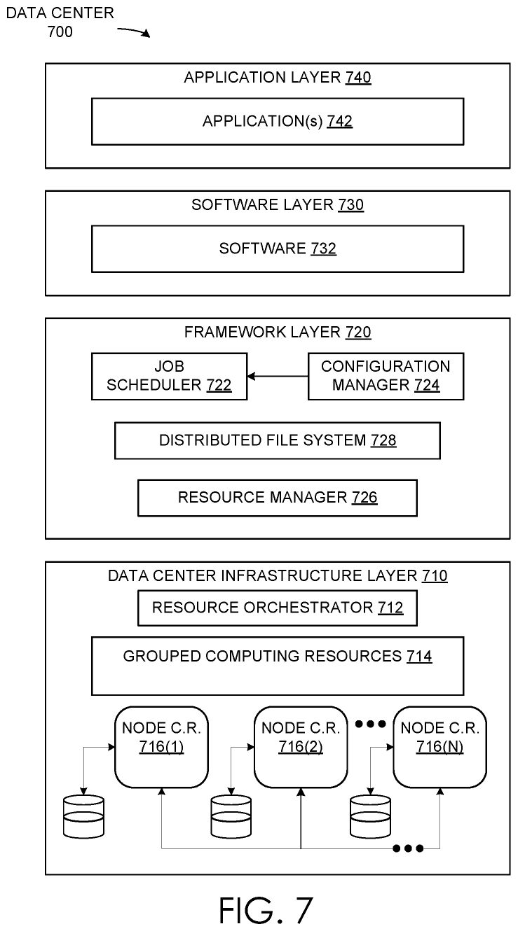

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used for storing and retrieving information in interaction environments.

### Computer Systems

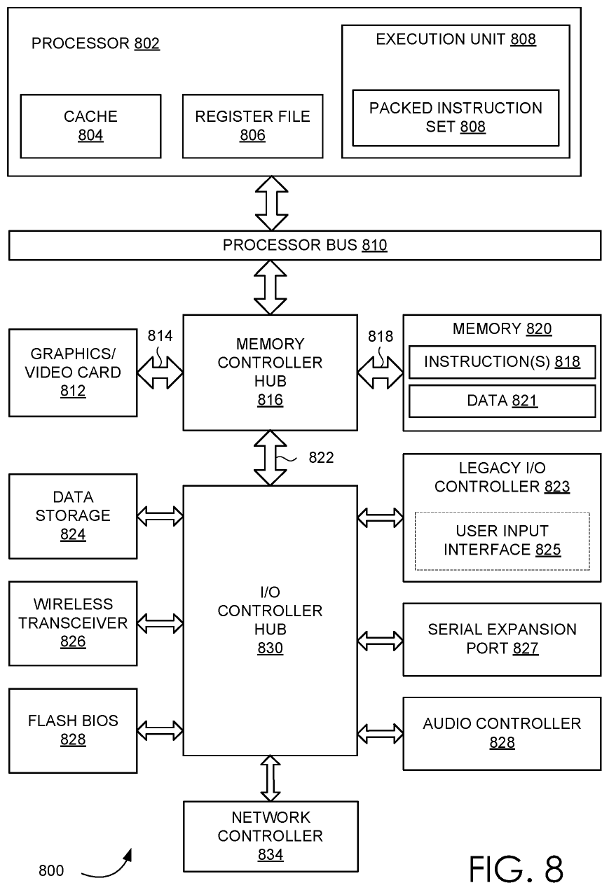

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, Calif., although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), edge computing devices, set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components can be used for storing and retrieving information in interaction environments.

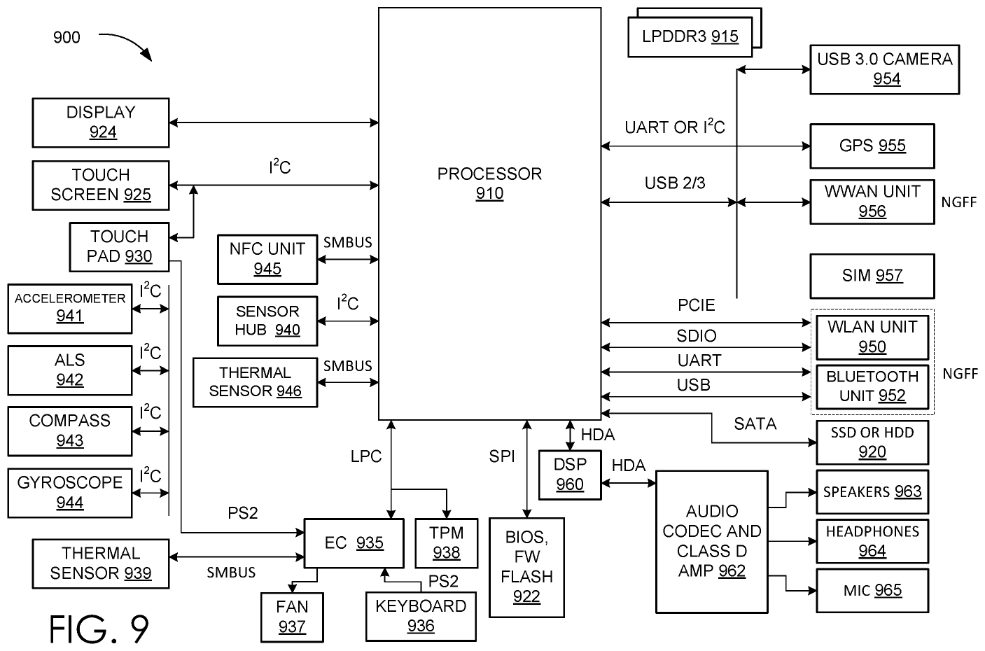

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 946, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used for storing and retrieving information in interaction environments.

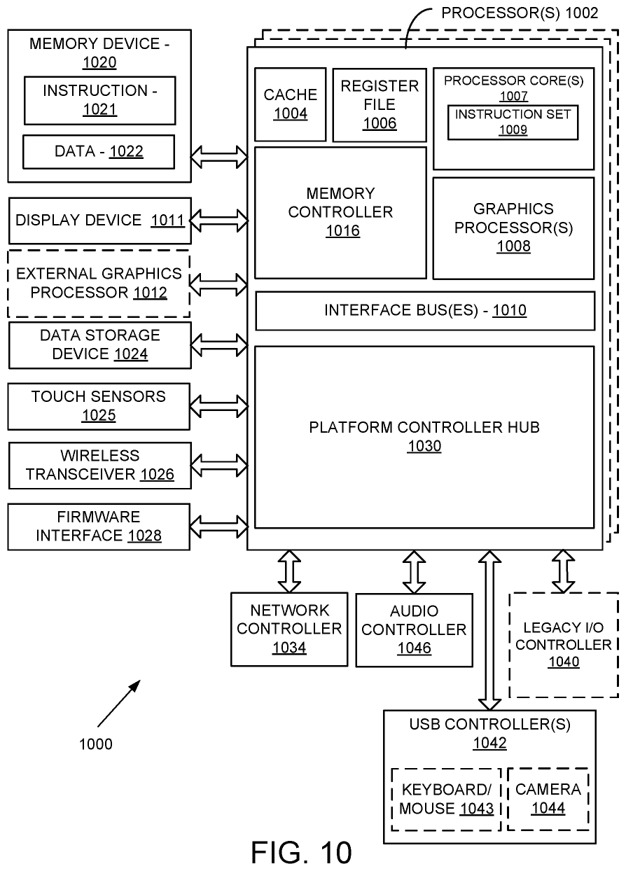

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system or datacenter having a large number of collectively or separably managed processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a cloud computing host platform, a virtualized computing platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, edge device, Internet of Things (“IoT”) device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used for storing and retrieving information in interaction environments.

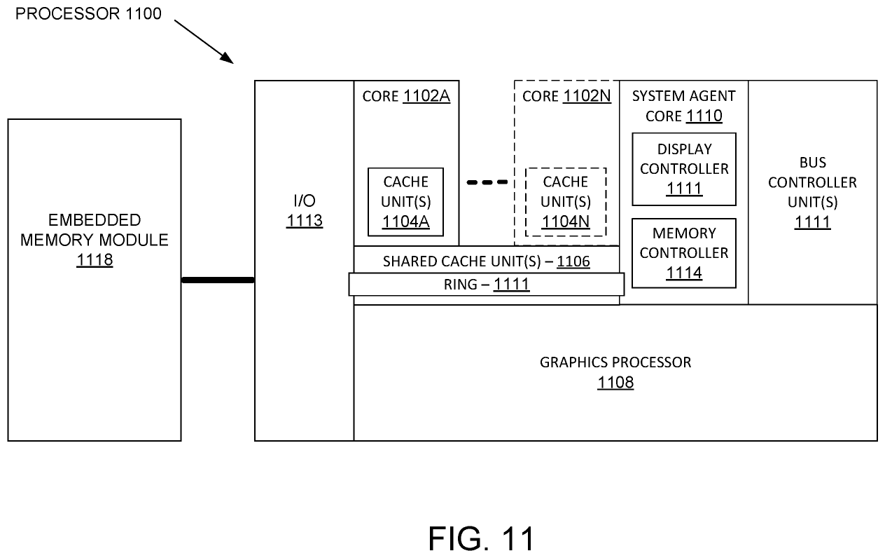

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used for storing and retrieving information in interaction environments.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, image signal processor (“ISP”), arithmetic logic unit (“ALU”), vision processing unit (“VPU”), tree traversal unit (“TTU”), ray tracing core, tensor tracing core, tensor processing unit (“TPU”), embedded control unit (“ECU”), and the like. As non-limiting examples, “processor” may be a hardware accelerator, such as a PVA (programmable vision accelerator), DLA (deep learning accelerator), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more processing units to:
receive a query to an interaction environment;
determine a classification for the query corresponds to an information based query;
extract, from the query, a text sequence;
determine, based at least in part on the text sequence, a response to the query; and
provide the response to the query.

2. The processor of claim 1, wherein the response is identified within unstructured text.

3. The processor of claim 1, wherein the one or more processing units are further to:
receive the response using a trained generative neural network model; and
generate an answer using the trained generative neural network model based, at least in part, on the response and an extracted portion of the query.

4. The processor of claim 3, wherein the one or more processing units are further to:
receive an informative statement; and
store the informative statement as a natural language statement.

5. The processor of claim 4, wherein the one or more processing units are further to:
receive a second query to the interaction environment;
determine the classification for the second query is a second information based query;
determine the second query is associated with the informative statement; and
perform one or more tasks based, at least in part, on the informative statement.

6. The processor of claim 1, wherein the one or more processing units are further to execute a task, responsive to query, based, at least in part, on the response.

7. The processor of claim 1, wherein the one or more processing units are further to:
determine an identifier associated with the response; and
cause one or more actions to be performed based, at least in part, on the identifier.

8. The processor of claim 1, wherein the one or more processing units are further to execute an extractive question and answer model, and wherein the one or more processing units use extractive question answer model to determine the response to the query.

9. The processor of claim 1, wherein the query is at least one of an auditory input, a textual input, or a selectable input.

10. A method, comprising:
storing a plurality of facts as unstructured plain text within a dataset;
receiving a user query associated with a parameter of an interaction environment;
extracting, from the user query, a text sequence;
determining, within the dataset, one or more selected facts associated with the text sequence; and
generating a response based, at least in part, on the one or more selected facts.

11. The method of claim 10, wherein the text sequence is extracted and the one or more selected facts are determined using a trained extractive question answer model.

12. The method of claim 10, wherein the response is a natural language response based, at least in part, on an output of a generative neural network model.

13. The method of claim 10, further comprising:
receiving an informative input; and
storing, in a natural language format, the informative input within the dataset.

14. The method of claim 13, further comprising:
receiving a second user query;
determining a classification of the second user query;
retrieving, based at least in part on the classification, one or more portions of the informative input; and
executing one or more tasks based, at least in part, on the one or more portions.

15. The method of claim 10, further comprising:
determining one or more calls associated with the text sequence, the one or more calls corresponding to an action; and
causing the action to be performed based, at least in part, on the response.

16. A computer-implemented method, comprising:
receiving an informational input from a user;
storing, as natural language, the information input;
receiving a user query to perform a task;
determining a classification of the user query;
extracting, from the user query, a segment associated with the task;
retrieving, based at least in part on the segment, at least a portion of the informational input; and
executing the task based, at least in part, on the informational input.

17. The computer-implemented method of claim 16, further comprising:
determining one or more actions associated with the informational input; and
assigning one or more tags to the informational input.

18. The computer-implemented method of claim 16, wherein an extractive question answer model determines the portion of the informational input.

19. The computer-implemented method of claim 16, wherein the informal input is added to an unstructured dataset.

20. The computer-implemented method of claim 16,
receiving at least the portion to a trained generative neural network model;
generating an auditory indicator associated with at least the portion.
